(19) United States
(12) Patent Application Publication
(10) Pub. No.: US 2014/0249264 A1
(43) Pub. Date: Sep. 4, 2014

(54) HIGH-FLUIDITY HETEROPHASIC PROPYLENE COPOLYMER WITH IMPROVED RIGIDITY

(71) Applicant: TOTAL RESEARCH & TECHNOLOGY FELUY, SENEFFE (BE)

(72) Inventors: Isabelle Ydens, Trivieres (BE); Geoffroy Terlinden, Wezembeek-Oppem (BE); Alain Standaert, Bruxelles (BE); David Ribour, Mairieux (FR)

(21) Appl. No.: 14/349,442

(22) PCT Filed: Oct. 2, 2012
(86) PCT No.: PCT/EP2012/069490

§ 371 Date: Apr. 3, 2014

(30) Foreign Application Priority Data
Oct. 7, 2011 (EP) 11184269.6

(51) Int. Cl. C08L 23/08

(52) U.S. Cl. CPC C08L 23/08
USPC 524/528; 525/240; 264/328.14

(57) ABSTRACT

Heterophasic propylene copolymers can include a matrix phase and a dispersed phase. The heterophasic propylene copolymers can be characterized by good processability and good mechanical properties, particularly an improved rigidity. The heterophasic propylene copolymers can be well-suited for injection molding applications, particularly for injection molding of thin-walled articles.

### FIELD OF THE INVENTION

The present invention relates to heterophasic propylene copolymers comprising a matrix phase and a dispersed phase. Said heterophasic propylene copolymers are characterized by good processability and good mechanical properties, particularly an improved rigidity. The present heterophasic propylene copolymers are well-suited for injection molding applications, particularly for injection molding of thin-walled articles. The present invention further relates to a process for producing such heterophasic propylene copolymers and to articles produced therewith.

### THE TECHNICAL PROBLEM AND THE PRIOR ART

Polypropylene offers a unique combination of good economics with good properties, such as good thermal properties, chemical resistance, or processability. However, propylene homopolymers and random copolymers have the major drawback of being deficient in impact strength, particularly at lower temperatures. Only by introducing an impact modifier, such as a rubber, into propylene homopolymer or random copolymer has it been possible to overcome this deficiency and extend the use of polypropylene into applications that require increased impact strength.

The blending of a propylene homopolymer or random copolymer, either by compounding or directly in the polymerization process, with a rubber leads to a polypropylene with two distinct phases, the matrix phase and the rubber phase. This is the reason why such polypropylenes are best described as heterophasic propylene copolymers, though frequently they are also referred to as “impact copolymers” or just “propylene block copolymers”. A typical example of such a heterophasic propylene copolymer is one with a propylene homopolymer or a propylene random copolymer matrix and an ethylene-propylene rubber (EPR).

The production of polypropylene articles can for example be done by injection molding wherein molten polypropylene is injected into a mold and then cooled, thus solidifying. The injection-molded article is finally ejected from the mold.

Because polypropylene is available over a wide range of melt flow indices, which are an indication of the fluidity, it also offers the possibility to produce a wide variety of injection-molded articles, ranging for example from relatively thick-walled articles, such as garden furniture or crates for the automotive industry, to thin-walled articles, such as yoghurt pots or margarine tubs.

However, increasing the melt flow index will normally result in lower mechanical properties. Polypropylene manufacturers have therefore continuously tried improving the mechanical properties of higher fluidity polypropylenes. While progress has been made, this is not sufficient in light of the continuing pressure to obtain the same function with ever less material.

In this regards, recent developments in polymerization catalysts, such as the introduction and commercialization of succinate catalysts, have allowed to improve the rigidity of polypropylenes, but at the same time keeping a level of impact performance sufficient for the targeted end-use applications. This has, however, been possible only for polypropylenes having a melt flow index up to 20 dg/min, which is insufficient for modern thin-wall injection molding. There is therefore a need to find a polymerization process which would also allow the use of such new polymerization catalysts to produce polypropylene having a higher melt flow index while at least maintaining the mechanical properties.

It is therefore an objective of the present invention to provide a polypropylene having good fluidity, i.e. having an elevated melt flow index.

It is also an objective of the present invention to provide a polypropylene with good processability in injection molding.

It is a further objective of the present invention to provide a polypropylene with a good combination of mechanical properties.

Furthermore, it is an objective of the present invention to provide a polypropylene with good stiffness or good impact properties or preferably with both.

In addition, it is an objective of the present invention to provide a polypropylene that allows to reduce the wall thickness of injection-molded articles while keeping the mechanical properties of such injection-molded article.

It is an additional objective of the present invention to provide a production process allowing the production of such high fluidity polypropylenes.

### BRIEF DESCRIPTION OF THE INVENTION

We have now found that any of the above objectives can be attained either individually or in any combination by the heterophasic propylene copolymer defined herein.

Hence, the present application provides a heterophasic propylene copolymer consisting of
A) a propylene polymer matrix (M) comprising one or more propylene polymers, independently selected from propylene homopolymer and random copolymer of propylene and at least one further olefin different from propylene, and
B) a dispersed elastomer phase (D) comprising one or more elastomers, said one or more elastomers comprising a first olefin, which is different from propylene, and a second olefin, which is different from the first olefin,
   wherein the heterophasic propylene copolymer is characterized by
(i) a melt flow index of at least 30 dg/min and of at most 200 dg/min, determined according to ISO 1133, condition L, at 230° C. and 2.16 kg;
(ii) a molecular weight distribution, defined as the ratio M_{w}/Mₙ of weight average molecular weight M_{w} and number average molecular weight Mₙ and measured by size exclusion chromatography, of at least 10 and of at most 30;
(iii) a dispersed elastomer phase wherein said first olefin is present in an amount of at least 3.0 wt % and of at most 15 wt %, relative to the total weight of the heterophasic propylene copolymer, with the amount of first olefin being determined by ¹³C-NMR spectroscopy on the acetone insoluble fraction of the xylene soluble fraction of the heterophasic propylene copolymer;
(iv) having been produced in presence of a Ziegler-Natta polymerization catalyst comprising an internal electron donor, said internal electron donor comprising at least 80 wt %, relative to the total weight of said internal electron donor, of at least one compound selected from the group consisting of succinates, di-ketones and enamino-imines; and
(v) having a ratio η_{D}/η_{M} of at least 1.0 and of at most 4.5, with η_{D} being the intrinsic viscosity of the dispersed phase and η_{M} being the intrinsic viscosity of the matrix phase, both measured in tetralin at 135° C.

The present application also provides articles comprising this heterophasic propylene copolymer.

In addition, the present application provides a process for the production of the heterophasic propylene copolymer of claim 1, said process comprising the steps of
(a) producing the propylene polymer matrix by polymerizing propylene or polymerizing propylene and at least one further olefin different from propylene,
(b) subsequently transferring said propylene polymer matrix obtained in step (a) to a further polymerization reactor, and
(c) producing the dispersed elastomer phase in a polymerization reactor by copolymerizing a first olefin, which is different from propylene, and a second olefin, which is different from the first olefin,
   wherein steps (a) and (c) are performed in presence of a Ziegler-Natta polymerization catalyst and an aluminum alkyl, and wherein the Ziegler-Natta polymerization catalyst comprises at least 80 wt %, relative to the total weight of internal donor, of at least one compound selected from the group consisting of succinates, di-ketones and enamino-imines, and wherein in step (c) the molar ratio n₁/(n₁+n₂) with n₁ being the number of mol of the first olefin and n₂ being the number of mol of the second olefin present in the respective polymerization reactor is at least 10 mol % and at most 35 mol %.

### DETAILED DESCRIPTION OF THE INVENTION

The properties of the polymers and articles are determined as indicated in detail in the test methods.

For the purposes of the present application, the terms “elastomer” and “rubber” are used synonymously.

The present inventors have now discovered that at least one of the above objectives can be met by providing a specific polypropylene, which is a heterophasic propylene copolymer consisting of
A) a propylene polymer matrix (M), and
B) a dispersed elastomer phase (D),
   wherein the propylene polymer matrix comprises one or more propylene polymers and the dispersed elastomer phase comprises one or more elastomers.

The heterophasic propylene copolymer of the present invention has a melt flow index of at least 30 dg/min and of at most 200 dg/min. Preferably, the melt flow index is at least 40 dg/min, even more preferably at least 50 dg/min and most preferably at least 60 dg/min. Preferably, the melt flow index is at most 150 dg/min or 140 dg/min, more preferably at most 130 dg/min, even more preferably at most 120 dg/min, still even more preferably at most 110 dg/min and most preferably at most 100 dg/min.

The heterophasic propylene copolymer of the present invention has a molecular weight distribution, defined as the ratio M_{w}/Mₙ of weight average molecular weight M_{w} and number average molecular weight Mₙ and measured by size exclusion chromatography, of at least 10 and of at most 30, preferably of at least 10 and of at most 20, more preferably of at least 10 and of at most 15.

The heterophasic propylene copolymer of the present invention has a ratio η_{D}/η_{M} of the intrinsic viscosity η_{D} of the dispersed elastomer phase and the intrinsic viscosity η_{M} of the propylene polymer matrix of at least 1.0 and of at most 4.5. Preferably, said ratio η_{D}/η_{M} is at least 1.5, more preferably at least 2.0 an most preferably at least 2.5. Said ratio η_{D}/η_{M} is preferably at most 4.0 and most preferably at most 3.5. Both, η_{M} and η_{D}, may be determined as indicated in the test methods.

Preferably, the heterophasic propylene copolymer used herein is characterized by a flexural modulus of at least 1300 MPa, determined as indicated in the test methods. More preferably said flexural modulus is at least 1400 MPa. Most preferably it is at least 1500 MPa.

Preferably, the heterophasic propylene copolymer used herein is characterized by an Izod impact strength at 23° C. as well as at −20° C. of at least 2 kJ/m², determined as indicated in the test methods.

Preferably, the heterophasic propylene copolymer has a spiral flow of at least 350 cm at 500 bar pressure. More preferably, said spiral flow is at least 400 cm. Most preferably it is at least 450 cm. Spiral flow is determined as indicated in the test methods.

### Propylene Polymer Matrix

The propylene polymer matrix (M) of the heterophasic propylene copolymer of the present invention comprises polymers, independently selected from propylene homopolymer and random copolymer of propylene and at least one, preferably of one only, further olefin different from propylene. Said further olefin is present in at most 4.0 wt %, relative to the total weight of the random copolymer, preferably in at most 3.5 wt %, more preferably in at most 3.0 wt %, even more preferably in at most 2.5 wt % and most preferably in at most 2.0 wt % relative to the total weight of the random copolymer. Preferably said further olefin is present in at least 0.01 wt %, relative to the total weight of the random copolymer. Preferably said further olefin is an α-olefin, more preferably an α-olefin having 2 or from 4 to 10 carbon atoms. Even more preferably said further α-olefin is selected from the group consisting of ethylene, 1-butene, 1-pentene, 4-methyl-1-pentene, 1-hexene, or 1-octene. Most preferably, said further α-olefin is ethylene.

The most preferred propylene polymer matrix is a propylene homopolymer.

It is preferred that the propylene polymer matrix has a tacticity of more than 95.0% of mmmm pentads. The percentage of mmmm pentads is determined on the insoluble heptane fraction of the xylene soluble fraction according to the method described by G. J. Ray et al. in Macromolecules, vol. 10, no 4, 1977, p. 773-778. Preferably the tacticity is more than 96.0%, 97.0%, or 98.0% of mmmm pentads. In other words, it is preferred that the propylene polymer matrix is comprised of a propylene polymer that is predominantly isotactic.

If the propylene polymer matrix is a propylene homopolymer it is preferred that its xylene solubles content is at most 5.0 wt %, even more preferably at most 4.5 wt %, and most preferably at most 4.0 wt %, relative to the total weight of the propylene homopolymer. Preferably the xylene solubles content is at least 0.5 wt %, relative to the total weight of the propylene homopolymer. The xylene solubles content is determined as indicated in the test methods.

The molecular weight distribution of the propylene polymer matrix may be monomodal or multimodal, for example bimodal. A multimodal molecular weight distribution is obtained by combining at least two propylene polymers having different melt flow indices, i.e. showing at least two peaks in a size exclusion chromatogram. For the present invention it is preferred that the propylene polymer matrix has a monomodal molecular weight distribution.

### Dispersed Elastomer Phase

The dispersed elastomer phase (D) of the heterophasic propylene copolymer comprises one or more elastomers. The elastomer of the heterophasic propylene copolymer of the present invention comprises a first olefin, which is different from propylene, and a second olefin, which is different from the first olefin. Preferably, said first and second olefin are independently selected from the group consisting of ethylene and α-olefins. Specific examples for α-olefins that may be used are ethylene, propylene, 1-butene, 1-pentene, 4-methyl-1-pentene, 1-hexene, and 1-octene. As first olefin ethylene and butene are more preferred, with ethylene being most preferred. It is most preferred that the second olefin is propylene. Thus, the most preferred elastomer is an ethylene-propylene rubber (EPR).

Said first olefin is present in an amount of at least 3.0 wt % and at most 15 wt % of the total weight of the heterophasic propylene copolymer. Preferably, said first olefin is present in an amount of at least 3.5 wt % and most preferably of at least 4.0 wt %. Preferably, said first olefin is present in an amount of at most 12 wt %, more preferably of at most 10 wt % or 9.0 wt %, even more preferably of at most 8.0 wt %, still even more preferably of at most 7.0 wt % and most preferably of at most 6.0 wt %. The comonomer content may for example be determined by ¹³C-NMR spectroscopy of the acetone insoluble fraction of the xylene soluble fraction of the heterophasic propylene copolymer as described in the test methods.

For the present application it is preferred that the dispersed elastomer phase is present in an amount from 10.0 wt % to 22.0 wt %, preferably from 10.0 wt % to 20.0 wt %. The elastomer content of the heterophasic propylene copolymer is determined as the acetone insoluble fraction of the xylene soluble fraction of the heterophasic propylene copolymer as indicated in the test methods.

Preferably, the dispersed elastomer phase has an intrinsic viscosity η_{D} in the range from 1.0 dl/g to 3.0 dl/g. More preferably said intrinsic viscosity is in the range from 1.5 dl/g to 2.5 dl/g, and most preferably in the range from 1.7 dl/g to 2.3 dl/g. The intrinsic viscosity η_{D} is determined in tetralin at 135° C. on the acetone insoluble fraction of the xylene soluble fraction of the heterophasic propylene copolymer.

Preferably, the propylene polymer matrix and the dispersed elastomer phase, when taken together, comprise at least 90 wt % of the heterophasic propylene copolymer. More preferably, they comprise at least 95.0 wt % or 97.0 wt % or 99.0 wt %, even more preferably at least 99.5 wt % of the heterophasic propylene copolymer. Most preferably the heterophasic propylene copolymer essentially consists of the propylene polymer matrix and the dispersed elastomer phase.

The heterophasic propylene copolymer of the present invention may also comprise additives, such as for example antioxidants, light stabilizers, acid scavengers, lubricants, antistatic agents, fillers, nucleating agents, clarifying agents, colorants. An overview of useful additives is given in Plastics Additives Handbook, ed. H. Zweifel, 5^{th} edition, Hanser Publishers.

Preferably, the heterophasic propylene copolymers may contain one or more nucleating agents. The nucleating agent used in the present invention can be any of the nucleating agents known to the skilled person. It is, however, preferred that the nucleating agent be selected from the group consisting of talc, carboxylate salts, sorbitol acetals, phosphate ester salts, substituted benzene tricarboxamides and polymeric nucleating agents, as well as blends of these. The most preferred nucleating agents are talc, carboxylate salts, and phosphate ester salts.

The carboxylate salts used as nucleating agents in the present invention can be organocarboxylic acid salts. Particular examples are sodium benzoate and lithium benzoate. The organocarboxylic acid salts may also be alicyclic organocarboxylic acid salts, preferably bicyclic organodicarboxylic acid salts and more preferably a bicyclo[2.2.1]heptane dicarboxylic acid salt. A nucleating agent of this type is sold as HYPERFORM® HPN-68 by Milliken Chemical.

Examples for sorbitol acetals are dibenzylidene sorbitol (DBS), bis(p-methyl-dibenzylidene sorbitol) (MDBS), bis(p-ethyl-dibenzylidene sorbitol), bis(3,4-dimethyl-dibenzylidene sorbitol) (DMDBS), and bis(4-propylbenzylidene)propyl sorbitol. Bis(3,4-dimethyl-dibenzylidene sorbitol) (DMDBS) and bis(4-propylbenzylidene)propyl sorbitol are preferred. These can for example be obtained from Milliken Chemical under the trade names of Millad 3905, Millad 3940, Millad 3988 and Millad NX8000.

Examples of phosphate ester salts are salts of 2,2′-methylene-bis-(4,6-di-tert-butylphenyl)phosphate. Such phosphate ester salts are for example available as NA-11 or NA-21 from Asahi Denka.

Examples of substituted tricarboxamides are those of general formula (I)

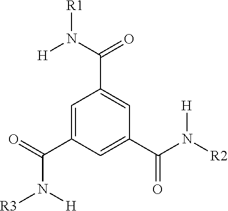

wherein R1, R2 and R3, independently of one another, are selected from C₁-C₂₀ alkyls, C₅-C₁₂ cycloalkyls, or phenyl, each of which may in turn by substituted with C₁-C₂₀ alkyls, C₅-C₁₂ cycloalkyls, phenyl, hydroxyl, C₁-C₂₀ alkylamino or C₁-C₂₀ alkyloxy etc. Examples for C₁-C₂₀ alkyls are methyl, ethyl, n-propyl, n-butyl, iso-butyl, tert-butyl, n-pentyl, iso-pentyl, 1,1-dimethylpropyl, 1,2-dimethylpropyl, 3-methylbutyl, hexyl, heptyl, octyl or 1,1,3,3-tetramethylbutyl. Examples for C₅-C₁₂ cycloalkyl are cyclopentyl, cyclohexyl, cyclooctyl, cyclododecyl, adamantyl, 2-methylcyclohexyl, 3-methylcyclohexyl or 2,3-dimethylcyclohexyl. Such nucleating agents are disclosed in WO 03/102069 and by Blomenhofer et al. in Macromolecules 2005, 38, 3688-3695.

Examples of polymeric nucleating agents are polymeric nucleating agents containing vinyl compounds, which are for example disclosed in EP-A1-0152701 and EP-A2-0368577. The polymeric nucleating agents containing vinyl compounds can either be physically or chemically blended with the polypropylene. In physical blending the polymeric nucleating agent containing vinyl compounds is mixed with the polypropylene in an extruder or in a blender. In chemical blending the polypropylene comprising the polymeric nucleating agent containing vinyl compounds is produced in a polymerization process having at least two stages, in one of which the polymeric nucleating agent containing vinyl compounds is produced. Preferred vinyl compounds are vinyl cycloalkanes or vinyl cycloalkenes having at least 6 carbon atoms, such as for example vinyl cyclopentane, vinyl-3-methyl cyclopentane, vinyl cyclohexane, vinyl-2-methyl cyclohexane, vinyl-3-methyl cyclohexane, vinyl norbornane, vinyl cylcopentene, vinyl cyclohexene, vinyl-2-methyl cyclohexene. The most preferred vinyl compounds are vinyl cyclopentane, vinyl cyclohexane, vinyl cyclopentene and vinyl cyclohexene.

Further, it is possible to use blends of nucleating agents, such as for example a blend of talc and a phosphate ester salt or a blend of talc and a polymeric nucleating agent containing vinyl compounds.

While it is clear to the skilled person that the amount of nucleating agent to be added depends upon its crystallization efficiency, for the purposes of the present invention the nucleating agent or the blend of nucleating agents is present in the polypropylene in an amount of at least 50 ppm, preferably at least 100 ppm. It is present in an amount of at most 10000 ppm, preferably of at most 5000 ppm, more preferably of at most 4000 ppm, even more preferably of at most 3000 ppm and most preferably of at most 2000 ppm.

The present heterophasic propylene copolymer, which consists of the propylene polymer matrix (M) and the dispersed phase (D) as defined above, is produced by the following process comprising the steps of
(a) producing the propylene polymer matrix (M) by polymerizing propylene or by polymerizing propylene and at least one further olefin different from propylene,
(b) subsequently transferring said propylene polymer matrix obtained in step (a) to a further polymerization reactor, and
(c) producing the dispersed elastomer phase (D) in a polymerization reactor by copolymerizing a first olefin, which is different from propylene, and a second olefin, which is different from the first olefin,
   wherein steps (a) and (c) are performed in presence of a Ziegler-Natta polymerization catalyst and an aluminum alkyl. Preferably, steps (a) and (c) are performed in presence of a Ziegler-Natta polymerization catalyst, aluminum alkyl and an external electron donor. Optionally hydrogen is present as well. Optionally, step (a) or step (c) or both may be performed in more than one polymerization reactor.

A Ziegler-Natta polymerization catalyst comprises a titanium compound, which has at least one titanium-halogen bond, and an internal donor, both supported on magnesium halide in active form. The internal donor comprises at least 80 wt %, relative to the total weight of said internal donor, of at least one, preferably only one, compound selected from the group consisting of succinates, di-ketones and enamino-imines. Preferably, the internal donor comprises at least 90 wt %, more preferably at least 95 wt %, even more preferably at least 97 wt %, still even more preferably at least 99 wt % and most preferably consists of at least one, preferably only one, compound selected from the group consisting of succinates, di-ketones and enamino-imines. The preferred compound is a succinate (“succinate catalyst”). The internal donor may also comprise at least one compound selected from phthalates or 1,3-diethers, provided that the polymerization behaviour essentially remains that of a Ziegler-Natta catalyst with a succinate, a di-ketone or an enamino-imine as internal donor.

We have now surprisingly found that the polymerization conditions for a Ziegler-Natta polymerization catalyst comprising an internal donor selected from the group consisting of succinates, di-ketones and enamino-imines, preferably comprising a single internal donor which is a succinate, can be modified to obtain a heterophasic propylene copolymer of high fluidity and good mechanical properties. This has been achieved by choosing the above-defined narrow intrinsic viscosity range for the dispersed elastomer phase and the above-defined specific ratio of the intrinsic viscosities of propylene polymer matrix and dispersed elastomer phase, and further by performing step (c), wherein the dispersed elastomer phase is produced by polymerizing a first olefin different from propylene and a second olefin different from the first one, in such a way that the so-called R ratio is at least 10 mol % and at most 35 mol %. Said R ratio is preferably at least 15 mol %, more preferably at least 20 mol % and most preferably at least 25 mol %. Said R ratio is defined as the molar ratio n₁/(n₁+n₂) with n₁ being the number of mol of the first olefin and n₂ the number of mol of the second olefin present in the polymerization reactor, as may for example be determined based on the respective feed rates to the polymerization reactor.

Suitable succinate compounds have the formula

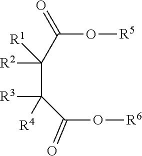

wherein R¹ to R⁴ are equal to or different from one another and are hydrogen, or a C₁-C₂₀ linear or branched alkyl, alkenyl, cycloalkyl, aryl, arylalkyl or alkylaryl group, optionally containing heteroatoms, and R¹ to R⁴, being joined to the same carbon atom, can be linked together to form a cycle; and R⁵ and R⁶ are equal to or different from one another and are a linear or branched alkyl, alkenyl, cycloalkyl, aryl, arylalkyl or alkylaryl group, optionally containing heteroatoms.

Suitable di-ketones are 1,3-di-ketones of formula

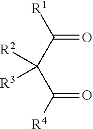

wherein R² and R³ are equal to or different from one another and are hydrogen, or a C1-C20 linear or branched alkyl, alkenyl, cycloalkyl, aryl, arylalkyl or alkylaryl group, optionally containing heteroatoms, and R² and R³, being joined to the same carbon atom, can be linked together to form a cycle; and R¹ and R⁴ are equal to or different from one another and are a linear or branched alkyl, alkenyl, cycloalkyl, aryl, arylalkyl or alkylaryl group, optionally containing heteroatoms.

Suitable enamino-imines have the general formula

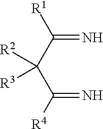

wherein R² and R³ are equal to or different from one another and are hydrogen, or a C1-C20 linear or branched alkyl, alkenyl, cycloalkyl, aryl, arylalkyl or alkylaryl group, optionally containing heteroatoms, and R² and R³, being joined to the same carbon atom, can be linked together to form a cycle; and R¹ and R⁴ are equal to or different from one another and are a linear or branched alkyl, alkenyl, cycloalkyl, aryl, arylalkyl or alkylaryl group, optionally containing heteroatoms.

The organoaluminum compound is advantageously an Al-trialkyl, such as Al-triethyl, Al-triisobutyl, Al-tri-n-butyl, and linear or cyclic Al-alkyl compounds containing two or more Al atoms bonded to each other by way of O or N atoms, or SO₄ or SO₃ groups. Al-triethyl is preferred. Advantageously, the Al-trialkyl has a hydride content, expressed as AlH₃, of less than 1.0 wt % with respect to the Al-trialkyl. More preferably, the hydride content is less than 0.5 wt %, and most preferably the hydride content is less than 0.1 wt %.

The organoaluminum compound is preferably used in such an amount as to have a molar ratio Al/Ti in the range from 1 to 1000. More preferably, the molar ratio Al/Ti is at most 250. Most preferably it is at most 200.

Suitable external electron donors (ED) include certain silanes, ethers, esters, amines, ketones, heterocyclic compounds and blends of these. It is preferred to use a 1,3-diether or a silane. It is most preferred to use a silane of the general formula

R^{a}ₚR^{b}_{q}Si(OR^{c})_{(4-p-q)}

wherein R^{a}, R^{b} and R^{c} denote a hydrocarbon radical, in particular an alkyl or cycloalkyl group, and wherein p and q are numbers ranging from 0 to 3 with their sum p+q being equal to or less than 3. R^{a}, R^{b} and R^{c} can be chosen independently from one another and can be the same or different. Specific examples of such silanes are (tert-butyl)₂Si(OCH₃)₂, (cyclohexyl)(methyl) Si(OCH₃)₂ (referred to as “C donor”), (phenyl)₂Si(OCH₃)₂ and (cyclopentyl)₂Si(OCH₃)₂ (referred to as “D donor”).

The molar ratio of organoaluminum compound to external donor (“Al/ED”) ranges advantageously between 1 and 500. Preferably the molar ratio Al/ED is at most 100, more preferably at most 50, even more preferably at most 20, and most preferably at most 15. Preferably the molar ratio Al/ED is at least 2.

Hydrogen is used to control the length and thus the intrinsic viscosity of the polymer chains so as to arrive at the respective melt flow index and the intrinsic viscosities as defined above. For the production of polymers with higher MFI, i.e. with lower average molecular weight and shorter polymer chains, the concentration of hydrogen in the polymerization medium needs to be increased. Inversely, the hydrogen concentration in the polymerization medium has to be reduced in order to produce polymers with lower MFI, i.e. with higher average molecular weight and longer polymer chains.

The production of the heterophasic propylene copolymers as defined above may be carried out using known polymerization processes in at least two serially connected polymerization reactors. The polymerization reactors may be selected independently from one another from the group consisting of gas phase reactors, slurry reactors and bulk reactors. It is, however, preferred that the production is first carried out in at least one loop reactor using bulk polymerization or polymerization in supercritical propylene to produce the propylene polymer matrix and then subsequently in one or more, preferably in one or two, most preferably in one only, gas phase reactors to produce the dispersed elastomer phase, wherein the reactors are serially connected and the polymerization in a reactor is performed in presence of the accumulated polymer produced in the preceding reactors.

The propylene polymer matrix may also be produced in more than one serially connected polymerization reactor, for example in two serially connected polymerization reactors, in which case the contribution of the first reactor to the total of the propylene polymer matrix is of from 40 wt % to 60 wt %, preferably in the range from 45 wt % to 55 wt % and most preferably in the range from 45 wt % to 50 wt %.

When the propylene polymer matrix is produced in more than one polymerization reactor, i.e. in at least two polymerization reactors, the propylene polymer may comprise fractions of propylene polymers that differ in average molecular weight and melt flow index. The molecular weight distribution of the resulting propylene polymer is multimodal. Otherwise, the molecular weight distribution is monomodal, i.e. the fractions do not differ significantly in average molecular weight and melt flow index.

A multimodal molecular weight distribution can be obtained by producing the fractions of the propylene polymer matrix in the at least two polymerization reactors under different polymerization conditions. The most convenient way to do so is having different hydrogen concentrations in the polymerization reactors.

For the present invention propylene homopolymers and random copolymers are preferably produced by polymerization in liquid propylene at temperatures in the range from 20° C. to 100° C. Preferably, temperatures are in the range from 60° C. to 80° C. The pressure can be atmospheric or higher. It is preferably between 25 and 50 bar.

Polymerization conditions, reactants' feed rates etc. are set in such a way as to result in the production of the heterophasic propylene copolymer with the characteristics that have been mentioned before. This is well within the skills of the person skilled in the art and does not require further details.

The heterophasic propylene copolymer is recovered as a powder after the last of the sequential polymerization reactors. It is optionally additivated with the already mentioned additives and can then be pelletized or granulated.

The heterophasic propylene copolymer of the present invention is particularly suited for the production of injection-molded articles. The injection molding process comprises the steps of
(i) melting the heterophasic propylene copolymer as defined above to obtain a molten heterophasic propylene copolymer, and
(ii) injecting the molten heterophasic propylene copolymer of step (i) into an injection mold to form an injection-molded article.

The injection molding is performed using methods and equipment well known to the person skilled in the art. An overview of injection molding and compression molding is for example given in Injection Molding Handbook, D. V. Rosato et al., 3^{rd} edition, 2000, Kluwer Academic Publishers. The heterophasic propylene copolymer is preferably injected into the injection mold at a melt temperature in the range from 200° C. to 300° C., more preferably in the range from 220° to 280° C.

The heterophasic propylene copolymer can be used for any article that is produced by injection molding. Examples of such articles may be pails, buckets, toys, household appliances, containers, caps, closures, and crates, to only name a few. The heterophasic propylene copolymer of the present invention is most particularly suited for pails and buckets.

### Test Methods

Melt flow index (MFI) is measured according to norm ISO 1133, condition L, 230° C., 2.16 kg.

Xylene solubles (XS) are determined as follows: Between 4.5 and 5.5 g of propylene polymer are weighed into a flask and 300 ml xylene are added. The xylene is heated under stirring to reflux for 45 minutes. Stirring is continued for 15 minutes exactly without heating. The flask is then placed in a thermostat bath set to 25° C.+/−1° C. for 1 hour. The solution is filtered through Whatman no 4 filter paper and exactly 100 ml of solvent are collected. The solvent is then evaporated and the residue dried and weighed. The percentage of xylene solubles (“XS”) is then calculated according to

XS(in wt %)=(Weight of the residue/Initial total weight of PP)*300

Acetone insolubles are determined as follow: 100 ml of the filtrate of the solution in xylene (see above) and 700 ml of acetone are agitated overnight at room temperature in a hermetically sealed flask, during which time a precipitate is formed. The precipitate is collected on a metal mesh filter with a mesh width of 0.056 mm, dried and weighed. The percentage of acetone insolubles (“AcIns”) is then calculated according to

AcIns(in wt %)=(Weight of the residue/Initial weight of PP)*300

The amount of ethylene-propylene rubber in heterophasic propylene copolymer is determined as the acetone insoluble fraction of the xylene soluble fraction.

Molecular weights and molecular weight distribution is determined by Size Exclusion Chromatography (SEC) at high temperature (145° C.). A 10 mg PP sample is dissolved at 160° C. in 10 ml of TCB (technical grade) for 1 hour. The analytical conditions for the Alliance GPCV 2000 from WATERS are:
Volume: +/−400 μl
Injector temperature: 140° C.
Column and detector: 145° C.
Column set: 2 Shodex AT-806MS and 1 Styragel HT6E
Flow rate 1 ml/min
Detector: Refractive index
Calibration: Narrow standards of polystyrene
Calculation (based on Mark-Houwink relation): log(M_{PP})=log(M_{PS})−0.25323

The total ethylene content (% C₂) is determined by ¹³C-NMR analysis of pellets according to the method described by G. J. Ray et al. in Macromolecules, vol. 10, no 4, 1977, p. 773-778. The ethylene (or comonomer) content of the dispersed elastomer phase is determined by ¹³C-NMR on the acetone insoluble fraction of the xylene soluble fraction of the heterophasic propylene copolymer.

The intrinsic viscosity η_{M} of the propylene polymer matrix (M), i.e. of the xylene insoluble fraction of the heterophasic propylene copolymer, is determined in a capillary viscometer in tetralin at 135° C. following ISO 1628.

The intrinsic viscosity η_{D} of the dispersed elastomer phase (D) is determined using the acetone insoluble fraction of the xylene soluble fraction of the heterophasic propylene copolymer. The intrinsic viscosity is determined in a capillary viscometer in tetralin at 135° C.

Flexural modulus was measured at 23° C. according to ISO 178.

Notched Izod impact strength was measured at 23° C. and −20° C. according to ISO 180.

Spiral flow was determined on a 90 ton Netstal injection molding machine with a screw having a diameter of 32 mm and a L/D ratio of 25. Melt temperature was 208° C. Injection pressure was set to 500 bar. Mold temperature was kept at 40±1° C.

### Examples

The advantages of the present invention are illustrated by the following examples.

The heterophasic propylene copolymers of Example 1 and Comparative Examples 1 and 2 consisted of a propylene homopolymer (PPH) as propylene polymer matrix (M) and an ethylene-propylene rubber (EPR) as dispersed elastomer phase (D). They were produced in a pilot plant having two 150 l loop reactors and a gas phase reactor (GPR) in series, wherein the propylene homopolymer matrix (PPH) and subsequently the ethylene-propylene rubber (EPR) were produced. For Example 1 and Comparative Example 2 a commercially available Ziegler-Natta polymerization catalyst with a succinate as internal donor was employed. Comparative Example 1 was produced using a commercially available Ziegler-Natta polymerization catalyst with a phthalate as internal donor. External donor was (cyclopentyl)₂Si(OCH₃)₂, abbreviated as “D”.

Further polymerization conditions are given in Table 1. Properties of the propylene polymer matrix and the dispersed elastomer phase are given in Table 2. Properties of the heterophasic propylene copolymer are indicated in Table 3.

TABLE 1

| | Unit | Ex. 1 | Comp. Ex. 1 | Comp. Ex. 2 |
|---|---|---|---|---|
| Catalyst | | Succinate | Phthalate | Succinate |
| External donor (ED) | | D | D | D |

Catalyst activation

| | | | | |
|---|---|---|---|---|
| TEAL/Propylene | g/kg | 0.09 | 0.14 | 0.14 |
| TEAL/ED | g/g | 14 | 2 | 5 |

GPR - Dispersed phase - EPR

| | | | | |
|---|---|---|---|---|
| n(C₂)/(n(C₂) + n(C₃)) | mol % | 0.30 | 0.38 | 0.38 |

TABLE 2

| | | | |
|---|---|---|---|
| Unit | Ex. 1 | Comp. Ex. 1 | Comp. Ex. 2 |

Matrix (M) - PPH

| | | | | |
|---|---|---|---|---|
| MFI | dg/min | 108 | 145 | 167 |
| Xylene solubles | wt % | 3.5 | | 1.8 |

Dispersed phase (D) - EPR

| | | | | |
|---|---|---|---|---|
| η_{D} | dl/g | 1.8 | 2.3 | 2.4 |
| Ratio η_{D}/η_{M} | | 2.6 | 4.0 | 4.4 |

TABLE 3

| | Unit | Ex. 1 | Comp. Ex. 1 | Comp. Ex. 2 |
|---|---|---|---|---|
| MFI | dg/min | 84 | 78 | 80.1 |
| Total ethylene content | wt % | 4.6 | 7.9 | 7.9 |
| Total xylene solubles | wt % | 14.6 | 15.7 | 14.2 |
| Acetone insolubles | wt % | 12.1 | 14.2 | 12.1 |
| Flexural modulus | MPa | 1700 | 1570 | 1950 |
| Izod, notched, 23° C. | kJ/m² | 4.6 | 4.9 | 2.7 |
| Izod, notched, −20° C. | kJ/m² | 3.5 | 3.3 | 2.2 |
| Spiral flow | cm | 570 | 550 | 560 |
| Mn | KDa | 16 | 21 | 15 |
| Mw | KDa | 169 | 155 | 175 |
| Mz | KDa | 891 | 532 | 923 |
| Mw/Mn | | 10.7 | 7.5 | 11.7 |
| Mz/Mw | | 5.3 | 3.4 | 5.3 |

Also for comparative reasons, the molecular weight distribution of the propylene copolymers described in example 1 and comparative example 1 of EP 2 141 200 were determined. Said molecular weight distribution were lower compared to those obtained for the propylene copolymers according to the present invention (Table 4).

TABLE 4

| | unit | Ex. 1 of EP 2 141 200 | Comp. Ex. 1 of EP 2 141 200 |
|---|---|---|---|
| Mn | KDa | 21 | 23 |
| Mw | KDa | 176 | 183 |
| Mz | KDa | 690 | 685 |
| Mw/Mn | | 8.5 | 8.1 |
| Mz/Mw | | 3.9 | 3.8 |

Particularly the data of Table 3 illustrates the advantages of the present invention. With respect to Comparative Example 1, the heterophasic propylene copolymer of Example 1 shows a significant increase in flexural modulus while at the same time maintaining the impact properties at ambient as well as at low temperatures. By contrast, Comparative Example 2 shows that a higher intrinsic viscosity in combination with the higher ratio η_{D}/η_{M} leads to impact properties that are below the requirements for a number of end-use applications and thus render the product inacceptable for applications such as for example margarine tubs and the like.

With respect to Comparative Example 2, the polymerization process of Example 1, i.e. with specifically adapted conditions for fluidity of the matrix and the dispersed phase as well as ethylene concentration in the production of the dispersed elastomer phase, allows the use of Ziegler-Natta polymerization catalysts with a succinate as internal donor for the production of high-fluidity heterophasic propylene copolymers, which can then be used for injection molding of thin-walled articles as illustrated by the increased spiral flow length.

In fact, when used in the injection molding of margarine tubs, the heterophasic propylene copolymer of Example 1 has shown very good results with respect to top load performance, which is linked to the rigidity, as well as for impact performance of such margarine tubs.

1-15. (canceled)

16. A heterophasic propylene copolymer comprising:
A) a propylene polymer matrix (M) comprising one or more propylene polymers, independently selected from propylene homopolymer and random copolymer of propylene and at least one further olefin different from propylene; and
B) a dispersed elastomer phase (D) comprising one or more elastomers, said one or more elastomers comprising a first olefin, which is different from propylene, and a second olefin, which is different from the first olefin, said dispersed elastomer phase (D) has an intrinsic viscosity η_{D} in the range from 1.0 dl/g to 2.3 dl/g, determined in tetralin at 135° C. on the acetone insoluble fraction of the xylene soluble faction of the heterophasic propylene copolymer;
wherein the dispersed elastomer phase (D) is present in an amount from 10.0 wt % to 20.0 wt %, relative to the total weight of the heterophasic propylene copolymer, determined as the acetone insoluble fraction of the xylene soluble fraction of the heterophasic propylene copolymer;
wherein the heterophasic propylene copolymer is characterized by:
(i) a melt flow index of at least 60 dg/min and of at most 200 dg/min, determined according to ISO 1133, condition L, at 230° C. and 2.16 kg;
(ii) a molecular weight distribution, defined as the ratio M_{w}/Mₙ of weight average molecular weight M_{w} and number average molecular weight Mₙ and measured by size exclusion chromatography, of at least 10 and of at most 30;
(iii) wherein said first olefin is present in an amount of at least 3.0 wt % and of at most 15 wt %, relative to the total weight of the heterophasic propylene copolymer, with the amount of the first olefin being determined by ¹³C-NMR spectroscopy on the acetone insoluble fraction of the xylene soluble fraction of the heterophasic propylene copolymer;
(iv) having been produced in presence of a Ziegler-Natta polymerization catalyst comprising an internal electron donor, said internal electron donor comprising at least 80 wt %, relative to the total weight of said internal electron donor, of at least one compound selected from the group consisting of succinates, di-ketones and enamino-imines; and
(v) having a ratio η_{D}/η_{M} of at least 1.0 and of at most 3.5, with η_{D} being the intrinsic viscosity of the dispersed elastomer phase (D) and η_{M} being the intrinsic viscosity of the propylene polymer matrix (M), both measured in tetralin at 135° C.

17. The heterophasic propylene copolymer according to claim 16, wherein the propylene polymer matrix (M) is a propylene homopolymer.

18. The heterophasic propylene copolymer according to claim 16, wherein the propylene polymer matrix (M) is a propylene homopolymer having a xylene solubles content of at most 5.0 wt %, relative to the total weight of said propylene homopolymer.

19. The heterophasic propylene copolymer according to claim 16, wherein the propylene polymer matrix (M) and the dispersed elastomer phase (D), when taken together, comprise at least 90.0 wt % of the heterophasic propylene copolymer.

20. The heterophasic propylene copolymer according to claim 16, further comprising a nucleating agent.

21. The heterophasic propylene copolymer according to claim, 16, having a flexural modulus of at least 1300 MPa, determined at 23° C. according to ISO 178.

22. The heterophasic propylene copolymer according to claim 16, having a notched Izod impact strength at 23° C. as well as at −20° C. of at least 2 kJ/m², determined according to ISO 180.

23. The heterophasic propylene copolymer according to claim 16, having a spiral flow length at 500 bar of at least 350 cm.

24. An article comprising the heterophasic propylene copolymer of claim 16.

25. A process for the production of the heterophasic propylene copolymer of claim 16, the process comprising:
(a) producing the propylene polymer matrix (M) by polymerizing the propylene or polymerizing the propylene and the at least one further olefin different from propylene;
(b) subsequently transferring said propylene polymer matrix (M) obtained in step (a) to a further polymerization reactor; and
(c) producing the dispersed elastomer phase (D) in a polymerization reactor by copolymerizing the first olefin, which is different from propylene, and the second olefin, which is different from the first olefin;
wherein steps (a) and (c) are performed in presence of the Ziegler-Natta polymerization catalyst and an aluminum alkyl, and wherein the Ziegler-Natta polymerization catalyst comprises at least 80 wt %, relative to the total weight of the internal electron donor, of at least one compound selected from the group consisting of succinates, di-ketones and enamino-imines, and wherein in step (c) the molar ratio n₁/(n₁+n₂) with n₁ being the number of moles of the first olefin and n₂ being the number of moles of the second olefin present in the respective polymerization reactor is at least 10 mol % and at most 35 mol %.

26. The process according to claim 25, wherein steps (a) and (c) are performed in presence of an external electron donor.

27. A process for the production of injection-molded articles, said process comprising:
(i) melting the heterophasic propylene copolymer of claim 16 to obtain a molten heterophasic propylene copolymer; and
(ii) injecting the molten heterophasic propylene copolymer of step (i) into an injection mold to form an injection-molded article.

28. A heterophasic propylene copolymer consisting essentially of:
A) a propylene polymer matrix (M) comprising one or more propylene polymers, independently selected from propylene homopolymer and random copolymer of propylene and at least one further olefin different from propylene; and
B) a dispersed elastomer phase (D) comprising one or more elastomers, said one or more elastomers comprising a first olefin, which is different from propylene, and a second olefin, which is different from the first olefin, said dispersed elastomer phase (D) has an intrinsic viscosity η_{D} in the range from 1.0 dl/g to 2.3 dl/g, determined in tetralin at 135° C. on the acetone insoluble fraction of the xylene soluble faction of the heterophasic propylene copolymer;
wherein the dispersed elastomer phase (D) is present in an amount from 10.0 wt % to 20.0 wt %, relative to the total weight of the heterophasic propylene copolymer, determined as the acetone insoluble fraction of the xylene soluble fraction of the heterophasic propylene copolymer;
wherein the heterophasic propylene copolymer is characterized by:
(i) a melt flow index of at least 60 dg/min and of at most 200 dg/min, determined according to ISO 1133, condition L, at 230° C. and 2.16 kg;
(ii) a molecular weight distribution, defined as the ratio M_{w}/Mₙ of weight average molecular weight M_{w} and number average molecular weight Mₙ and measured by size exclusion chromatography, of at least 10 and of at most 30;
(iii) wherein said first olefin is present in an amount of at least 3.0 wt % and of at most 15 wt %, relative to the total weight of the heterophasic propylene copolymer, with the amount of the first olefin being determined by ¹³C-NMR spectroscopy on the acetone insoluble fraction of the xylene soluble fraction of the heterophasic propylene copolymer;
(iv) having been produced in presence of a Ziegler-Natta polymerization catalyst comprising an internal electron donor, said internal electron donor comprising at least 80 wt %, relative to the total weight of said internal electron donor, of at least one compound selected from the group consisting of succinates, di-ketones and enamino-imines; and
(v) having a ratio η_{D}/η_{M} of at least 1.0 and of at most 3.5, with η_{D} being the intrinsic viscosity of the dispersed elastomer phase (D) and η_{M} being the intrinsic viscosity of the propylene polymer matrix (M), both measured in tetralin at 135° C.

29. A heterophasic propylene copolymer consisting of:
A) a propylene polymer matrix (M) comprising one or more propylene polymers, independently selected from propylene homopolymer and random copolymer of propylene and at least one further olefin different from propylene; and
B) a dispersed elastomer phase (D) comprising one or more elastomers, said one or more elastomers comprising a first olefin, which is different from propylene, and a second olefin, which is different from the first olefin, said dispersed elastomer phase (D) has an intrinsic viscosity η_{D} in the range from 1.0 dl/g to 2.3 dl/g, determined in tetralin at 135° C. on the acetone insoluble fraction of the xylene soluble faction of the heterophasic propylene copolymer;
wherein the dispersed elastomer phase (D) is present in an amount from 10.0 wt % to 20.0 wt %, relative to the total weight of the heterophasic propylene copolymer, determined as the acetone insoluble fraction of the xylene soluble fraction of the heterophasic propylene copolymer;
wherein the heterophasic propylene copolymer is characterized by:
(i) a melt flow index of at least 60 dg/min and of at most 200 dg/min, determined according to ISO 1133, condition L, at 230° C. and 2.16 kg;
(ii) a molecular weight distribution, defined as the ratio M_{w}/Mₙ of weight average molecular weight M_{w} and number average molecular weight Mₙ and measured by size exclusion chromatography, of at least 10 and of at most 30;
(iii) wherein said first olefin is present in an amount of at least 3.0 wt % and of at most 15 wt %, relative to the total weight of the heterophasic propylene copolymer, with the amount of the first olefin being determined by ¹³C-NMR spectroscopy on the acetone insoluble fraction of the xylene soluble fraction of the heterophasic propylene copolymer;
(iv) having been produced in presence of a Ziegler-Natta polymerization catalyst comprising an internal electron donor, said internal electron donor comprising at least 80 wt %, relative to the total weight of said internal electron donor, of at least one compound selected from the group consisting of succinates, di-ketones and enamino-imines; and
(v) having a ratio η_{D}/η_{M} of at least 1.0 and of at most 3.5, with η_{D} being the intrinsic viscosity of the dispersed elastomer phase (D) and η_{M} being the intrinsic viscosity of the propylene polymer matrix (M), both measured in tetralin at 135° C.
